(19) United States
(12) Patent Application Publication
(10) Pub. No.: US 2013/0264728 A1
(43) Pub. Date: Oct. 10, 2013

(54) METHOD FOR FABRICATING AN ELECTROPHORETIC DISPLAY DEVICE

(71) Applicants: Hey-Jin Myoung, Seoul (KR); Ho-Suk Song, Gyeonggi-do (KR); Hyeon-Jung Yoo, Gyeonggi-do (KR); Young-Seo Yoon, Seoul (KR)

(72) Inventors: Hey-Jin Myoung, Seoul (KR); Ho-Suk Song, Gyeonggi-do (KR); Hyeon-Jung Yoo, Gyeonggi-do (KR); Young-Seo Yoon, Seoul (KR)

(73) Assignee: KOLON INDUSTRIES, INC., Kwacheon-city, Kyungki-do (KR)

(21) Appl. No.: 13/994,353

(22) PCT Filed: Nov. 28, 2011
(86) PCT No.: PCT/KR2011/009119

§ 371 Date: Jun. 14, 2013

(30) Foreign Application Priority Data
Dec. 16, 2010 (KR) 1020100129055

(51) Int. Cl. G02F 1/167

(52) U.S. Cl. CPC G02F 1/167
USPC 264/1.24

(57) ABSTRACT

The present description is directed to a method for fabricating an electrophoretic display device that includes: forming a partition wall on a first substrate; filling a charged particle slurry in a three-dimensional space sectioned by a photo-curable or thermosetting resin layer and a sealant defining an edge on the resin layer; and combining the first substrate and the photo-curable or thermosetting resin layer together to have the partition wall immersed in the charged particle slurry, which fabrication method minimizes the defective proportion of final products and provides an electrophoretic display device with a high contrast ratio and enhanced visibility to implement high-quality text.

### TECHNICAL FIELD

The present invention relates to a method for fabricating an electrophoretic display device, and more particularly, to a method for fabricating an electrophoretic display device that minimizes a defective proportion of the final products and provides an electrophoretic display device with a high contrast ratio and enhanced visibility to implement high-quality text.

### BACKGROUND OF THE ART

Electronic paper or digital paper, also called e-paper, is an electronic device that is portable and can be opened at any time like a paper book, newspaper, or a paper magazine and written on like ordinary paper.

The electronic paper takes the form of an electrophoretic display, which is very advantageous over the conventional flat display in that it is bendable, has a much lower production cost, and is far superior in energy efficiency without requiring a separate backlight.

Such electronic paper has a high resolution or definition and a wide viewing angle, and is capable of providing a memory function such that the text does not disappear completely even when the power is switched off.

With these great advantages, the electronic paper can be used in a very wide range of applications, such as e-books or self-updating newspapers having a paper-like side and moving illustrations, a reusable paper display for mobile phones, a disposable TV screen, electronic wallpaper, and so forth, with vast potential for market growth.

According to implementation methods, the electronic paper can be categorized into electrophoretic displays, liquid crystal displays, toner displays (QR-LPD: quick-response liquid powder displays), and MEMS (micro-electro-mechanical system) displays.

Among these displays, the electrophoretic display is a display device based on the electrophoretic behavior of charged pigment particles suspended in a dielectric solvent, and forms a color or contrast by rearranging charged pigment particles under attraction upon application of a voltage difference between two opposing electrode panels.

Among the electrophoretic displays, the techniques most approaching commercialization are the microcapsule-based electrophoretic display and the microcell-based electrophoretic display, both of which use particles as color display elements.

The microcapsule-based electrophoretic display is a display device in which particle-containing microcapsules are sensitive to water or temperature and are buried in a multi-layered polymer matrix. Due to a limit in height of driving cells depending on the size of the capsules, the microcapsule-based electrophoretic display tends to have a long response time and a low contrast ratio.

Contrarily, the microcell-based electrophoretic display is flexibly controllable in driving height to acquire a short response time and a high contrast ratio, and is configured with microcell units that are regular and accurate in shape and size to implement a good ability of assigning color addresses.

Further, the microcell-based electrophoretic display has recently gained attention since it is available for roll-to-roll continuous processing and is thus suitable for large-scale production with a high yield.

The microcell-based electrophoretic display is, however, problematic in regards to the difficulty in forming partition walls constituting microcell units and carrying out the process of filling a charged particle slurry in the microcells and sealing the microcells without voids.

### DETAILED DESCRIPTION OF THE INVENTION

### Technical Objectives

It is an object of the present invention to provide a method for fabricating an electrophoretic display device that minimizes the defective proportion of final products and provides an electrophoretic display device with a high contrast ratio and enhanced visibility to implement high-quality text.

### Technical Solutions

The present invention provides a method for fabricating an electrophoretic display device that includes: forming a partition wall on a first substrate; filling a charged particle slurry in a three-dimensional space sectioned by a photo-curable or thermosetting resin layer and a sealant defining an edge on the resin layer; and combining the first substrate and the photo-curable or thermosetting resin layer together to have the partition wall immersed in the charged particle slurry.

Hereinafter, a method for fabricating an electrophoretic display device according to a specific embodiment of the invention will be explained in detail.

The term “microcell” as used herein refers to a concave unit formed in the shape of a cup in the electrophoretic display device. For example, the microcell can be a space defined by two opposing substrates and a partition wall formed between the two substrates.

In accordance with one embodiment of the present invention, a method for fabricating an electrophoretic display device is provided that includes: forming a partition wall on a first substrate; filling a charged particle slurry in a three-dimensional space sectioned by a photo-curable or thermosetting resin layer and a sealant defining an edge on the resin layer; and combining the first substrate and the photo-curable or thermosetting resin layer together to have the partition wall immersed in the charged particle slurry.

The conventional microcell-based electrophoretic display device is produced on a large scale through roll-to-roll processing, which process advantageously allows continuous formation of microcells and filling of the charged particle slurry in the microcells, but with some problems in that it has a difficulty in sealing without voids in the slurry filled in the microcells, and leaves leftovers of the charged particle slurry on the top of the microcells thereby causing a deterioration in adhesion with a sealing layer.

Accordingly, the inventors of the present invention studied methods for providing an electrophoretic display device with higher quality and completed the present invention, with an experimental finding that by combining electrodes with a given container or construction full of a charged particle slurry to immerse the partition wall formed on the substrate in the charged particle slurry, the voids of the microcells or the charge particle slurry can be effectively removed without an additional sealing process, thus ensuring production of a high-quality electrophoretic display device.

As distinct from the conventional fabrication method that involves direct injection of the charged particle slurry into the microcells sectioned by partition walls formed on a substrate, the fabrication method for electrophoretic display device according to the present invention forms the partition walls on the substrate to face downwards and immerses it in the charged particle slurry filled in a given container or construction.

Particularly, the base (bottom) side of the three-dimensional space full of the charged particle slurry is made of an elastic or viscoelastic photo-curable or thermosetting resin layer. This eliminates possible formation of voids caused by air penetration while the one side of the partition wall gets in contact with the photo-curable or thermosetting resin layer, and prevents leftovers of the slurry on the contact surface between the one side of the partition wall and the resin layer.

According to the fabrication method for an electrophoretic display device, the microcells are filled with the charged particle slurry and sealed without voids to minimize the defective proportion of the final products and provide an electrophoretic display device with a high contrast ratio and enhanced visibility to implement high-quality text.

In the fabrication method, the solvent used for the charged particle slurry is not limited in viscosity, which allows a choice of a variety of solvents.

The fabrication method may use, for example, a charged particle slurry having a viscosity of 1 to 100 cps as appropriately selected according to the conditions of the process. Preferably, a charged particle slurry with a viscosity of 1 to 30 cps is used for a fabrication process under typical conditions (i.e., 20 to 100° C.), and a slurry with a viscosity of 30 to 100 cps is used for a low-temperature process (i.e., −20 to 10° C.).

The three-dimensional space to be filled with the charged particle slurry may be sectioned by the photo-curable or thermosetting resin layer and the sealant defining the edge on the resin layer.

The three-dimensional space is available in different polyhedral shapes according to the shape of the display device to be fabricated. For example, the shape of the three-dimensional space may include, but is not limited to, a cube or a cuboid that has a base side made of the photo-curable or thermosetting resin layer and four lateral sides made of the sealant.

The three-dimensional space may be a polyhedral container or construction to be filled with the charged particle slurry.

The sealant may function to seal the lateral sides of the electrophoretic display device to be fabricated.

FIG. 1 is a schematic diagram showing the step of combining a first substrate having a partition wall formed with a cubical construction full of the charged particle slurry.

The term “cubical construction” as used herein refers to a construction including a base side formed by a photo-curable or thermosetting resin layer and a lateral side (edge) formed by the four sides made of a sealant.

FIG. 1 is provided for illustration only to explain the preparation method of the electrophoretic display device, and is not intended to limit the present invention.

As a partition wall e formed on a first substrate d is put into a cubical construction full of a charged particle slurry c, as shown in FIG. 1, the microcells are filled with the charged particle slurry and then sealed up by a photo-curable or thermosetting resin layer a.

In this regard, the partition wall is put deep enough to be in contact with the photo-curable or thermosetting resin layer.

Accordingly, the photo-curable or thermosetting resin layer of the cubical construction plays a role of a sealing layer for the microcells, and the four sides b of the cubical construction constitute the lateral sealing layer of the electrophoretic display device.

The term “substrate” as used herein refers to a base side constituting both outer sides (e.g., top and bottom sides) of an electrophoretic portion including microcells full of the charged particle slurry.

The substrate constitutes the outer sides of the microcells in the electrophoretic display device. There are different types of layers or constructions, or electrodes for electrophoresis, that can be formed on the one side of the substrate or included in the substrate.

Hence, the substrate may include a base layer, a conductive base layer, or an electrode layer.

The base layer may include any kind of known base materials or substrates applicable to display devices without specific limitation, such as, for example, thermoplastic or thermosetting resin, PET, PAN, PI, glass, etc.

The conductive base layer may include any kind of known conductive materials typically used for display devices without specific limitation, such as, for example, CNT, conductive polymers, etc.

The electrode layer may include any known electrode material used for display devices without specific limitation, with the provision that at least one of the electrode materials included in both substrates is preferably, for example, ITO, SnO₂, ZnO, or indium zinc oxide (IZO).

On the other hand, the fabrication method for an electrophoretic display device may include the step of forming a partition wall on the first substrate.

The space for microcells is defined as the partition wall is formed on the one side of the first substrate, and the partition wall gets in contact with the photo-curable or thermosetting resin layer.

The partition wall sections the microcell units in the electrophoretic display device.

Such a partition wall may be available in different cross-sectional shapes, such as a rectangle, a square, a trapezoid, etc. To acquire an enhanced contrast ratio in the electrophoretic display device, a trapezoidal cross-section is preferred, for example, a cross-section of which the side in contact with the first substrate is relatively long.

The height and thickness of the partition wall can be adequately regulated according to the characteristics of the electrophoretic display device and the charged particle slurry. For example, the partition wall may have a height of 10 to 100 μm and a thickness of 5 to 50 μm.

The term “the height of the partition wall” means the maximum vertical length of the partition wall perpendicular to the first substrate. For example, the height of the partition wall is defined as the maximum distance between the first substrate and the photo-curable or thermosetting resin layer.

The term “the thickness of the partition wall” means the maximum horizontal length of the partition wall horizontal to the first substrate.

The plane shape of the partition wall, that is, the shape of the cross-section of the partition wall horizontal to the first substrate, may determine the plane shape of the microcells.

The plane shape of the microcells may include a circle, a triangle, a quadrilateral, an oval, or any other polygon. With a view to implementing structural stability and a high contrast ratio, the microcells preferably have such a plane shape as a regular hexagon or a hexagon to form an entire shape like a beehive honeycomb.

The step of forming a partition wall on the first substrate may include applying a photosensitive resin composition on the first substrate, and performing exposure, development, and cleaning on the applied photosensitive resin composition to form a partition wall.

The photosensitive resin composition used to form the partition wall may include a photopolymerizable polymer compound, a photopolymerization initiator, and other additives.

Specific examples of the photopolymerizable polymer compound may include, but are not limited to, transparent acryl-based polymers, acryl silicon copolymers, acryl urethane copolymers, etc.

There are two types of photosensitive resin compositions: positive and negative. The exposed portion of the negative type of photosensitive resin composition is more difficult to dissolve in the developer solution, while the exposed portion of the positive type of photosensitive resin composition is more soluble in the developer solution.

FIG. 2 is a schematic diagram showing an example of the step of forming a partition wall using a negative type of photosensitive resin composition.

The step of forming a partition wall on the first substrate is not specifically limited to this exemplary illustration. Thus, a positive type of photosensitive resin composition can also be used to form the partition wall.

The photosensitive resin composition for forming a partition wall may be applied on the first substrate through a typical application method, such as spin coating, bar coating, screen printing, spin-less coating, or the like; or a lamination method using a dry film photoresist.

The photosensitive resin composition thus applied can be patterned through processes of pre-baking, exposure, development, post-baking, and cleaning.

The processes of pre-baking, exposure, development, post-baking, and cleaning may adopt any known method, conditions, and apparatus typically used to form a photosensitive resin, without specific limitations.

The fabrication method for an electrophoretic display device may further include forming a second substrate on the other side of the photo-curable or thermosetting resin layer.

In the fabrication method for an electrophoretic display device, the first substrate on which the partition wall is formed is combined with the photo-curable or thermosetting resin layer, and then the second substrate is combined with the other side of the photo-curable or thermosetting resin layer. In another way, the photo-curable or thermosetting resin layer is formed on the second substrate and then combined with the first substrate on which the partition wall is formed.

The first and second substrates may be placed opposite to each other in the electrophoretic display device.

The first and second substrates may be separated from each other in opposite positions by a predetermined distance of, for example, 10 to 100 μm, which is not intended to limit the scope of the present invention.

The fabrication method for an electrophoretic display device may further include forming a photo-curable or thermosetting resin layer, and forming an edge consisting of a sealant on the photo-curable or thermosetting resin layer.

The photo-curable or thermosetting resin layer and the edge formed on the resin layer define a three-dimensional space that can be filled with a charged particle slurry.

The photo-curable or thermosetting resin layer may be formed by applying and curing a photo-curable or thermosetting resin on a given base material or a second substrate.

The applying step may use a known application method as already described above.

In the curing step, the curing method depends on the type of the resin used. For example, the curing method may include thermal curing that involves heating to 50° C. or above, photo-curing that involves UV radiation, or a combined method of thermal curing and photo-curing.

As described above, the photo-curable or thermosetting resin layer preferably has elasticity and viscoelasticity. This is not only to prevent possible formation of voids caused by air penetration while the one side of the partition wall gets in contact with the photo-curable or thermosetting resin layer, but also to avoid leftovers of the slurry on the contact surface between the one side of the partition wall and the resin layer.

Accordingly, the photo-curable or thermosetting resin layer may be partly cured, for example, about 50 to 80% cured, to have elasticity and viscoelasticity until the step of combining the first substrate having the partition wall with the photo-curable or thermosetting resin layer.

The degree of partial curing can be indicated by the relative cure percentage with respect to the completely cured photo-curable or thermosetting resin layer. The relative cure percentage is represented by the specific properties of the partly cured photo-curable or thermosetting resin layer, such as viscosity, adherence, hardness, or degree of swelling in a given solvent in comparison with those of the completely cured photo-curable or thermosetting resin layer.

Accordingly, the resin layer can be partly cured, for example, about 50 to 80% cured, by properly regulating a thermal curing temperature, intensity of UV radiation, curing time, etc. in the step of forming the photo-curable or thermosetting resin layer.

The resin layer thus partly cured may be further cured, for example, 100% cured, after the first substrate is combined with the cubical construction.

The photo-curable or thermosetting resin layer may include any kind of known photo-curable or thermosetting resins that are not soluble in the charged particle slurry, without any specific limitation.

For example, the photo-curable resin layer may include urethane acrylate, epoxy acrylate, polyester acrylate, acrylic acrylate, glycidyl acrylate, cycloaliphatic epoxide, acetylene or vinyl benzene, vinyls (e.g., vinyl acrylate or vinyl ether), esters, or polymers or oligomers containing the aforementioned functional groups. The thermosetting resin layer may include an epoxy resin (e.g., a bisphenol A type resin, a novolac resin, an epoxy acrylate, etc.).

On the other hand, the edge on the photo-curable or thermosetting resin layer may be formed by applying and curing a sealant on the photo-curable or thermosetting resin layer.

The application step may use the typical application method as described above.

The type of sealant used in the curing step may determine the curing method, which includes, for example, thermal curing that involves heating up to 50° C. or above, photo-curing that involves UV radiation, or a composite method of thermal curing and photo-curing.

In the case that the sealant includes a photo-curable resin, the processes of pre-baking, exposure, development, and post-baking are sequentially performed to form a sealant edge at a predetermined thickness and height.

The degree of cure for the sealant edge depends on the characteristics of the display device to be fabricated. For ease in combining the first substrate with the cubical construction, the edge-defining sealant may be partly cured, for example, about 50 to 80% cured, to have elasticity and viscoelasticity until the step of combining the first substrate with the photo-cured or thermosetting resin layer.

As described above, the degree of partial cure is indicated by the relative cure percentage with respect to the completely cured sealant edge. The relative cure percentage is represented by the specific properties of the partly cured sealant edge, such as, for example, viscosity, adherence, hardness, or degree of swelling in a given solvent, in comparison with those of the completely cured resin.

Accordingly, the edge can be partly cured, for example, about 50 to 80% cured, by properly regulating the thermal curing temperature, the intensity of UV radiation, the curing time, etc. in the step of forming an edge including the sealant.

The edge thus partly cured may be further cured, for example, 100% cured, after the first substrate is combined with the cubical construction.

The sealant may include any kind of known compounds for a sealant without any specific limitation.

For example, the sealant may be a thermosetting sealant or a photo-curable sealant.

More specifically, the thermosetting sealant may include epoxy resins, such as a bisphenol A type epoxy resin, a bisphenol F type epoxy resin, a novolac epoxy resin, a cycloaliphatic epoxy resin, etc. The photo-curable sealant may include an acrylate-based resin, a polyene/polythiol-based resin, spiran resin, a vinyl ether resin, etc.

Preferably, the sealant includes a filler such as silica in order to prevent air or water penetration.

On the other hand, the edge on the photo-curable or thermosetting resin layer may be formed from the same components as the photo-curable or thermosetting resin layer.

In this case, the edge with a predetermined thickness and height can be formed by applying a photo-curable or thermosetting resin to a given basic material or substrate and then applying a sealant to the edge of the resulting resin layer.

In other words, when the photo-curable or thermosetting resin layer and the edge are made of the same component, the process may include forming the photo-curable or thermosetting resin layer, and forming the edge including a sealant on the photo-curable or thermosetting resin layer.

The method of using the same component for the photo-curable or thermosetting resin layer and the edge on the photo-curable or thermosetting resin layer involves a single-step process to cure the resin layer and the edge at one time without a need for an additional step to form the edge, consequently imparting enhanced economic feasibility and efficiency of the fabrication process.

The fabrication method for electrophoretic display device may further include additionally curing the photo-curable or thermosetting resin layer after the first substrate with the partition wall is combined with the photo-curable or thermosetting resin layer.

As already described above, the photo-curable or thermosetting resin layer preferably has elasticity and viscoelasticity and hence is not completely cured. The photo-curable or thermosetting resin layer can be further cured after being combined with the first substrate, thereby completely sealing up the microcells.

In the case that the photo-curable or thermosetting resin layer and the edge are formed from the same component as described above, the edge of the resin layer can be cured at the same time in the step of curing the photo-curable or thermosetting resin layer.

The term “charged particle slurry” as used herein refers to a slurry including charged particles and a fluid medium.

The fluid medium may include, but is not limited to, a solvent having a viscosity of 20 cP or less, preferably a hydrocarbon-based solvent having a viscosity of 20 cP or less.

The fluid medium may also be a solvent having a dielectric constant of 2 to 30.

Specific examples of the fluid medium may include, but are not limited to, hydrocarbons such as decahydronaphthalene (DECALIN), 5-ethylidene-2-norbornene, fatty oil, or paraffin oil (e.g., Isopar G, Isopar L, Isopar M, etc.); aromatic hydrocarbons such as toluene, xylene, phenylxylyl ethane, dodecyl benzene, or alkyl naphthalene; halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane, or pentachlorobenzene; perfluoro solvents; or lower halogen solvents containing polymers such as perfluoropolyalkylether.

Depending on the characteristics of the electrophoretic display device, the fluid medium may be transparent, semitransparent, or colored. The semitransparent or colored fluid medium is colored with a pigment.

The pigment used to color the fluid medium may include any kind of known pigments available for a charged particle slurry without any specific limitation. Preferred examples of the pigment may include non-ionic azo pigments, anthraquinone pigments, or fluorinated pigments.

The charged particles may be self-charged or electrically charged by a charge control agent.

The charged particles filled in the microcells move up and down according to an applied voltage to implement contrast and color.

The charge control agent may be any kind of known charge control agents used for electrically charging particles without any specific limitation.

The size of the charged particles is not specifically limited, but is preferably in the range from several hundreds of nanometers to several sub-microns.

The charged particles are required to be chemically stable, not being swollen or softened in the fluid medium.

The charged particle slurry is to be insusceptible to sedimentation, coagulation, or agglomeration under the typical operational conditions for electrophoretic display devices.

The charged particles can be selected depending on the color to implement with the electrophoretic display device.

For example, the charged particles to implement whiteness may include metallic inorganic particles, such as TiO₂, MgO, ZnO, CaO, ZrO₂, etc., or their organic compounds. The charged particles to implement a color may include organic or inorganic pigments, such as ferric oxides, CrCu, carbon black, etc.

However, specific examples of the charged particles available in the present invention are not limited to those listed above, and may include any kind of charged particles known in the art.

The charged particles can be colored with a coloring pigment. Specific examples of the coloring pigment may include phthalocyanine blue, phthalocyanine green, diarylide yellow, diarylide AAOT yellow, quinacridone pigments, azo pigments, rhodamine pigments, perylene pigments, Hansa yellow G particles, etc.

Specific examples of the pigment used to color the charged particles are not limited to those listed above, and may include any kind of known pigments insoluble in the fluid medium and used to color the charged particles.

To implement a specific color to the fluid medium, the charged particle slurry may further include a coloring pigment, such as, if not limited to, phthalocyanine blue, phthalocyanine green, diarylide yellow, diarylide AAOT yellow, or quinacridone pigments, azo pigments, rhodamine pigments, perylene pigments, Hansa yellow G particles, carbon black, etc.

The charged particles may have a core-shell structure including an organic substance on the surface in order to control the density and the quantity of electric charge.

The charged particles and the fluid medium are uniformly dispersed by a known combining method of, for example, grinding, milling, attriting, microfluidizing, or ultrasound treatment, to form a charged particle slurry.

A known injection or filling method typically applicable to the electrophoretic display device can be used in the step of filling the charged particle slurry in the three-dimensional space sectioned by the photo-curable or thermosetting resin layer and the sealant defining the edge on the resin layer.

The quantity of the charged particle slurry filled in the space may be properly controlled according to the characteristics of the electrophoretic display device to be fabricated and the volume of the formed microcells.

Preferably, the charged particle slurry is used as much as about 97 to 105% of the volume of the microcells formed on the first substrate in order to prevent formation of voids or bubbles in the microcell units and leftovers of the charged particle slurry on the partition wall and the second substrate.

The fabrication method for an electrophoretic display device can provide an electrophoretic display device with at least one microcell.

More specifically, the fabrication method provides an electrophoretic display device with a regular or irregular arrangement of microcells that come in different plane shapes, such as, for example, a hexagon, a rectangle, or a square.

The microcells may be independently the same or different from one another in shape.

### Advantageous Effect of the Invention

The present invention can provide a method for fabricating an electrophoretic display device that minimizes the defective proportion of final products and provides an electrophoretic display device with a high contrast ratio and enhanced visibility to implement high-quality text.

### BRIEF DESCRIPTION OF THE DRAWINGS

FIG. 1 is a schematic diagram showing the step of combining a first substrate having a partition wall with a construction full of a charged particle slurry.

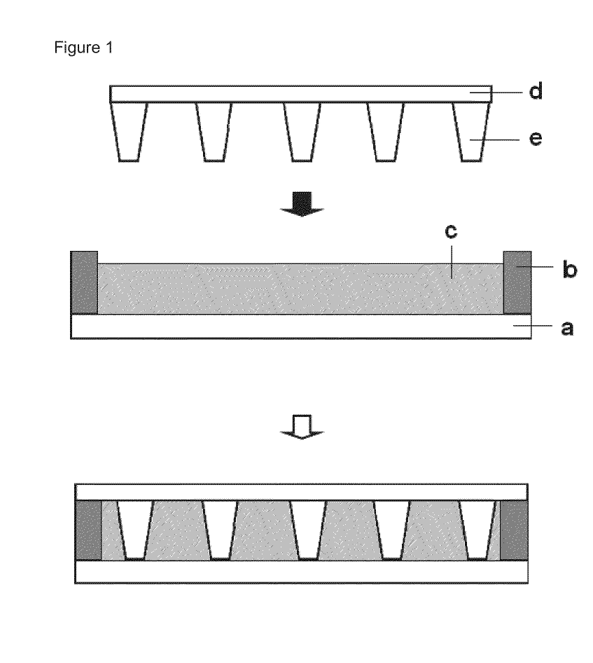

FIG. 2 is a schematic diagram showing the step of forming a partition wall on the first substrate.

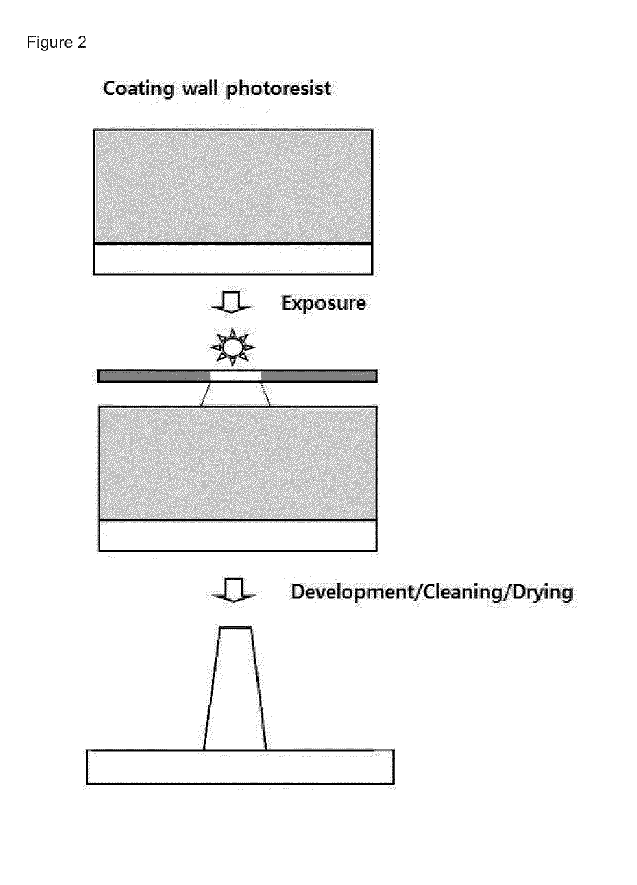

FIG. 3 is a schematic cross-sectional diagram of the construction full of the charged particle slurry.

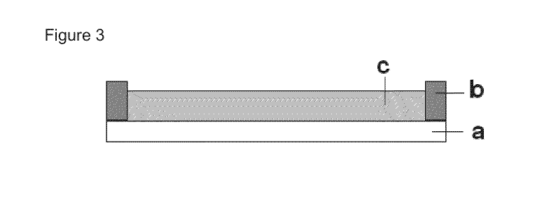

FIG. 4 is a partial diagram of an electrophoretic display device fabricated in Example 1.

FIG. 5 is a partial diagram of an electrophoretic display device fabricated in Example 2.

FIG. 6 is a partial diagram of an electrophoretic display device fabricated in a comparative example.

### DETAILS FOR PRACTICING THE INVENTION

Hereinafter, the present invention is explained in more detail in the following examples. However, the following examples are only for illustrating the present invention and the scope of the present invention is not limited by them.

### EXAMPLES AND COMPARATIVE EXAMPLES

### Fabrication of Electrophoretic Display Device

### Example 1

(1) Forming a Microcell-Shaped Partition Wall on a First Substrate

A dry film photoresist (Accuimage®, BU-6200 series, Kolon Industries Inc.) was used to form a partition wall on an ITO/PET film (6 inches long and 5 mm thick).

More specifically, the dry film photoresist was a composite solution consisting of a polyimide, a binder resin (i.e., cross-linked oligomers such as urethane acrylate or polyester acrylate), a photo-initiator, and a photopolymerizable monomer. The dry film photoresist was applied on the ITO/PET film by coating and then sequentially subjected to exposure using a square-shaped mask (maximum diagonal line: 50 μm), development, and cleaning to form a partition wall.

In this regard, the partition wall had a cross-section in the form of a trapezoid (with an 8 μm top side and a 10 μm bottom side), and its height was 30 μm.

(2) Forming a Photo-Curable Resin Layer and an Edge on a Second Substrate

A solution containing a transparent acryl-based photoresist (Onlymer PV®, Kolon Industries Inc.) and silica (30%) was applied to an ITO electrode (6 in) by spin coating and then sequentially subjected to pre-baking, exposure, development, and post-baking to form a photo-curable resin layer and an edge on the ITO film.

In this regard, the speed (rpm) of the spin coating was controlled to form the edge 30 μm in height, and the pattern size of the photomask was controlled to form the edge 20 μm in thickness.

The photo-curable resin layer and the edge were in a 60% cured state.

In this regard, the partly or completely cured state means the degree of cure as indicated by the relative degree of swelling in a methylethyl ketone (MEK) solvent.

More specifically, the substrate with the photo-curable resin layer and the edge was immersed at 23° C. for 4 hours and then measured in regards to the dimensional change with a contact surface profiler (Alpha Step). Further, the degree of partial cure was determined by the difference in volume change between the completely cured state and the partly cured state.

(3) Filling a Charged Particle Slurry

White charged particles having a density of 1.2 to 1.4 g/cm³ and a fluid medium containing a pigment and additives were mixed together at a mixing ratio of 1:2, and then homogenized with a rotor-stator homogenizer (IKA ULTRA-TURRAX T25, IKA WORKS) at room temperature for 10 minutes to obtain a charge particle slurry (viscosity: 20 cps).

Subsequently, the charged particle slurry was injected into the space formed by the photo-curable resin layer on the second substrate and the edge.

In this regard, the volume of the microcell defined by the partition wall formed in the step (1) was calculated so that the quantity of the charged particle slurry injected into the microcell was 101% of the total volume of the microcell.

(4) Combining the First Substrate Having the Partition Wall with the Second Substrate Having the Photo-Curable Resin Layer and the Edge

A laminator was used at 80° C. to immerse the first substrate having the partition wall into the charged particle slurry at a linear speed of 20 cm/min and combine the partition wall on the first substrate with the photo-curable resin layer on the second substrate.

The photo-curable resin layer and the edge on the second substrate in the 60% cured state were then completely cured by additional heat and UV radiation.

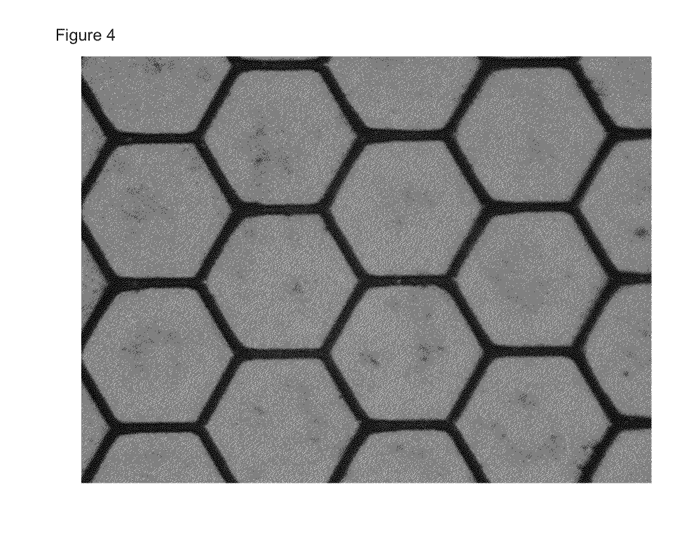

(5) An observation of the completed electrophoretic display device with a reflective digital microscope (Xi-Cam BV410, Bestecvition Co., Ltd.) showed that the respective microcells were uniformly sealed up without any void inside and that the partition wall and the photo-curable resin layer were firmly combined together without any separation between them. FIG. 4 is a partial illustration of the observed electrophoretic display device.

### Example 2

(1) The procedures were performed to fabricate an electrophoretic display device in the same manner as described in Example 1, excepting that the partition wall was formed through exposure using a square-shaped mask, development, and cleaning in the step of forming a microcell-shaped partition wall on a first substrate.

(2) An observation of the completed electrophoretic display device with a reflective digital microscope (Xi-Cam BV410, Bestecvition Co., Ltd.) showed the same results as Example 1 that the respective microcells were uniformly sealed up without any void inside and that the partition wall and the photo-curable resin layer were firmly combined together without any separation between them.

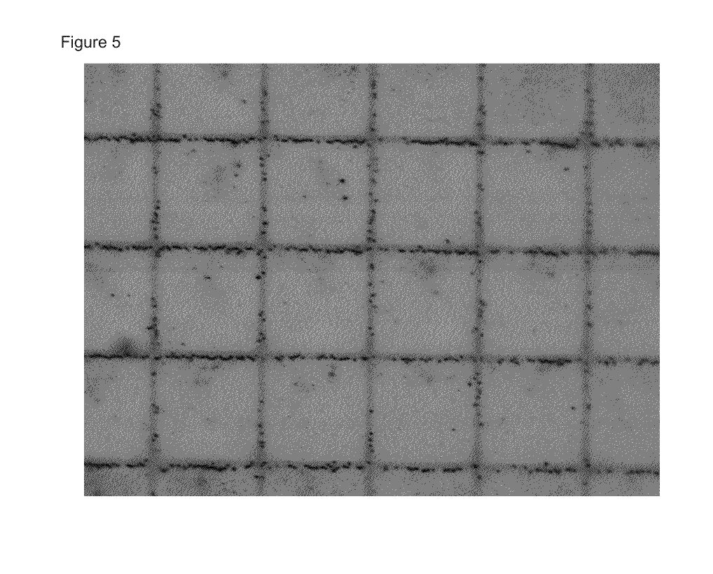

FIG. 5 is a partial illustration of the observed electrophoretic display device.

### Example 3

(1) The procedures were performed to fabricate an electrophoretic display device in the same manner as described in Example 1, excepting that the temperature was maintained at 4° C. in the step of combining the first substrate having the partition wall with the second substrate having the photo-curable resin layer and the edge.

(2) An observation of the completed electrophoretic display device with a reflective digital microscope (Xi-Cam BV410, Bestecvition Co., Ltd.) showed the same results as Example 1 that the respective microcells were uniformly sealed up without any void inside and that the partition wall and the photo-curable resin layer were firmly combined together without any separation between them.

### COMPARATIVE EXAMPLE

(1) The procedures were performed in the same manner as described in Example 2 to form a microcell-shaped partition wall on a first substrate.

(2) White charged particles having a density of 1.2 to 1.4 g/cm³ and a fluid medium containing a pigment and additives were mixed together at a mixing ratio of 1:2 and then homogenized with a rotor-stator homogenizer (IKA ULTRA-TURRAX T25, IKA WORKS) at room temperature for 10 minutes to obtain a charge particle slurry (viscosity: 20 cps).

The charged particle slurry was injected into the microcell formed on the first substrate.

(3) A water-curable adhesive was over-coated on a second substrate, which was then combined with the first substrate having microcells filled with the slurry.

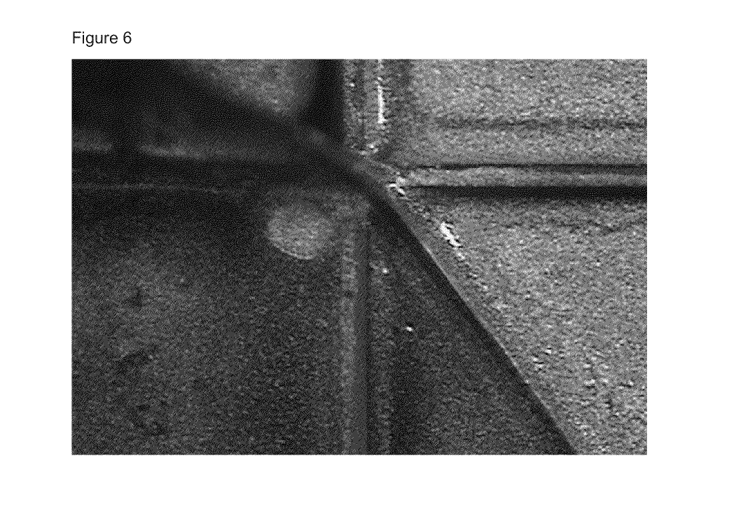

(4) An observation of the completed electrophoretic display device with a reflective digital microscope (Xi-Cam BV410, Bestecvition Co., Ltd.) showed, as illustrated in FIG. 6, that some microcell units had voids or bubbles inside, with leftovers of the charged particle slurry on the top of the partition wall. This implicitly showed that the adhesive on the second substrate was not completely combined with the partition wall.

### DESCRIPTION OF REFERENCE NUMERALS AND SIGNS

a: photo-curable or thermosetting resin layer

b: sealant

c: charged particle slurry

d: first substrate

e: partition wall

What is claimed is:

1. A method for fabricating an electrophoretic display device, comprising:
(a) forming a partition wall on a first substrate;
(b) filling a charged particle slurry in a three-dimensional space sectioned by a photo-curable or thermosetting resin layer and a sealant defining an edge on the resin layer; and
(c) combining the first substrate and the photo-curable or thermosetting resin layer together to have the partition wall immersed in the charged particle slurry.

2. The method as claimed in claim 1, which further comprises forming a second substrate on the other side of the photo-curable or thermosetting resin layer.

3. The method as claimed in claim 1, wherein the step (a) of forming a partition wall on a first substrate comprises:
applying a photo-sensitive resin composition on the first substrate; and
performing exposure, development, and cleaning on the applied photo-sensitive resin composition to form a partition wall.

4. The method as claimed in claim 1, wherein the partition wall has a height of 10 μm to 100 μm and a thickness of 5 μm to 50 μm.

5. The method as claimed in claim 1, wherein the charged particle slurry has a viscosity of 1 cps to 100 cps at −20 to 100° C.

6. The method as claimed in claim 1,
which further comprises forming a photo-curable or thermosetting resin layer; and
forming an edge comprising a sealant on the photo-curable or thermosetting resin layer.

7. The method as claimed in claim 1, wherein the photo-curable or thermosetting resin layer is partly cured until the step (c) of combining with the first substrate.

8. The method as claimed in claim 7, which further comprises additional curing the photo-curable or thermosetting resin layer subsequent to the step (c) of combining with the first substrate.

9. The method as claimed in claim 1, wherein the sealant defining the edge is partly cured until the step (c) of combining with the first substrate.

10. The method as claimed in claim 9, further comprising
additionally curing the sealant defining the edge, subsequent to the step (c) of combining with the first substrate.

11. The method as claimed in claim 1, wherein the method is used to fabricate an electrophoretic display device having at least one microcell formed thereon.

12. The method as claimed in claim 11, wherein the method is used to fabricate an electrophoretic display device with a regular or irregular arrangement of microcells having at least one plane shape selected from the group consisting of a hexagon, a rectangle, and a square.
